(19) United States
(12) Patent Application Publication
(10) Pub. No.: US 2023/0126429 A1
(43) Pub. Date: Apr. 27, 2023

(54) System for Testing the Padding of a Robotic Manipulator

(71) Applicant: ABB Schweiz AG, Baden (CH)

(72) Inventors: Bjoern Matthias, Bad Schönborn (DE); Christoph Byner, Mannheim (DE); Debora Clever, Zwingenberg (DE); Rene Kirsten, Fernwald (DE)

(73) Assignee: ABB Schweiz AG, Baden (CH)

(21) Appl. No.: 18/088,085

(22) Filed: Dec. 23, 2022

Related U.S. Application Data
(63) Continuation of application No. PCT/EP2020/067611, filed on Jun. 24, 2020.

(51) Int. Cl. G01L 5/00; G01M 7/08; G01M 99/00; G01L 5/22; B25J 19/02

(52) U.S. Cl. CPC G01L 5/0052; G01M 7/08; G01M 99/007; G01L 5/226; B25J 19/02

(57) ABSTRACT

A system and method for testing the padding of a robotic manipulator includes at least one sensor; a processing unit; and an output unit. The at least one sensor is configured to acquire sensor data of a robotic manipulator. The at least one sensor is configured to provide the sensor data to the processing unit. The processing unit is configured to determine information relating to padding applied to the robotic manipulator, wherein the determination comprises a comparison of the sensor data with reference data. The output unit is configured to output the information relating to the padding applied to the robotic manipulator.

### CROSS-REFERENCE TO RELATED APPLICATIONS

This patent application claims priority to International Patent Application No. PCT/EP2020/067611, filed on Jun. 24, 2020, which is incorporated herein in its entirety by reference.

### FIELD OF THE DISCLOSURE

The present disclosure relates to a system for testing the padding of a robotic manipulator, a robotic system, and a method for testing the padding of a robotic manipulator.

### BACKGROUND OF THE INVENTION

The safety requirements for a robotic manipulator (especially when designed for collaborative applications) can include passive padding being attached to the manipulator. The safety concept for robotic manipulators in collaborative applications using power and force limiting (PFL) for personnel protection can then include passive padding being attached to the robotic manipulator. The padding then mitigates a person being injured if they are accidently struck by the robotic manipulator, through a reduction in the forces being applied to the person during the impact

However, with padding being part of the safety concept, the user of that manipulator must regularly check whether the padding is still in place and that it is still in the proper condition. This is (in most cases) specified by the supplier of the manipulator (e.g. in the operating manual) and is currently done manually (e.g. by visual inspection).

A visual inspection by the user is however cumbersome and error-prone. While damaged or missing padding might still be easily detected during a visual inspection, a degradation of the padding properties (e.g. damping) is almost impossible to be detected visually.

### BRIEF SUMMARY OF THE INVENTION

The present disclosure describes an improved technique to test the padding of a robotic manipulator to ensure that no padding is missing and/or that the padding continues to exhibit the correct properties.

In a first aspect, there is provided a system for testing the padding of a robotic manipulator, the system comprising:
at least one sensor;
a processing unit; and
an output unit.

The at least one sensor is configured to acquire sensor data of a robotic manipulator. The at least one sensor is configured to provide the sensor data to the processing unit. The processing unit is configured to determine information relating to padding applied to the robotic manipulator, wherein the determination comprises a comparison of the sensor data with reference data. The output unit is configured to output the information relating to the padding applied to the robotic manipulator.

In other words, sensor data of a robotic manipulator to which padding should be applied is acquired and compared against reference data to validate if all parts of the padding that should be there are there, and validate the condition and properties of the padding in an automated manner.

Such reference data can come from measurements or baseline data. However such reference data can also be derived from models or simulations, that for example can make use of bulk material properties.

### BRIEF DESCRIPTION OF THE SEVERAL VIEWS OF THE DRAWING(S)

FIG. 1 is a schematic representation of contact of a robotic manipulator with a human body region without (on the left side of the figure) and with (on the right side of the figure) padding applied to the robotic manipulator, in accordance with the disclosure.

FIG. 2 is a diagram of an exemplary behavior of contact area, force and pressure during collision without and with padding applied to the robotic manipulator of FIG. 1.

FIG. 3 shows a detailed example of a robotic manipulator and a dedicated object or obstacle and where the robotic manipulator has performed a defined or reference movement or motion in order that the robotic manipulator impacts the obstacle, and for the motion of the robotic manipulator before, during, and after the impact the motion characteristic quantities are measured such as position and joint torques of the robotic manipulator in accordance with the disclosure.

FIG. 4 shows a detailed example of a robotic manipulator and a camera or camera system used to obtain imagery of the padding applied to the robotic manipulator in accordance with the disclosure.

### DETAILED DESCRIPTION OF THE INVENTION

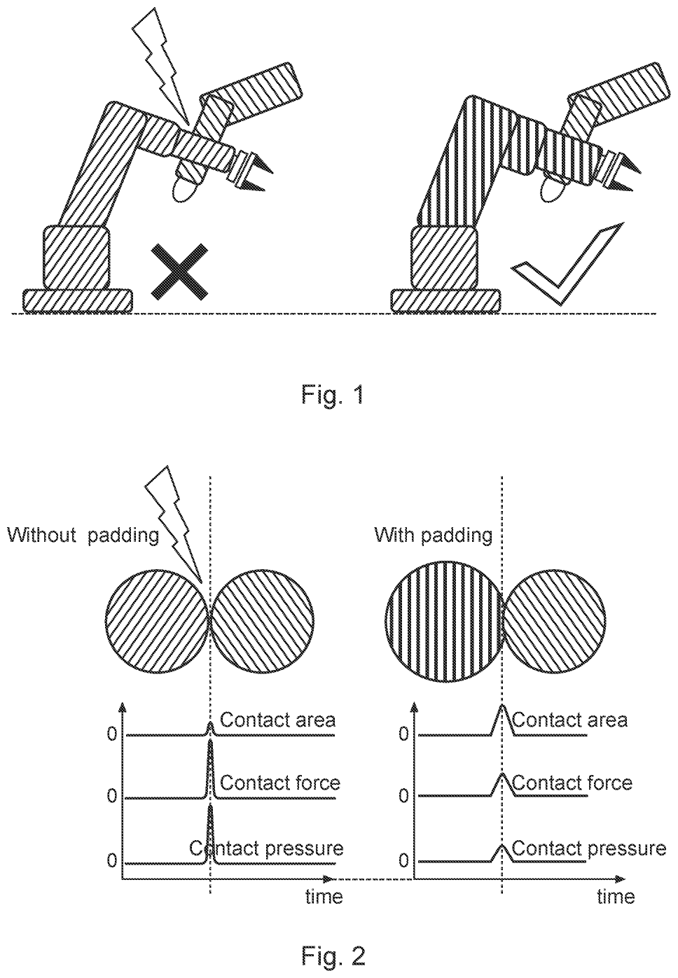

FIGS. 1-4 relate to a system for testing the padding of a robotic manipulator, a robotic system, and a method for testing the padding of a robotic manipulator.

The system for testing the padding of a robotic manipulator comprises at least one sensor, a processing unit, and an output unit. The at least one sensor is configured to acquire sensor data of a robotic manipulator. The at least one sensor is configured to provide the sensor data to the processing unit. The processing unit is configured to determine information relating to padding applied to the robotic manipulator, wherein the determination comprises a comparison of the sensor data with reference data. The output unit is configured to output the information relating to the padding applied to the robotic manipulator.

According to an example, the at least one sensor comprises one or more torque sensors configured to measure torque in one or more joints of the robotic manipulator. The processing unit is configured to move the robotic manipulator in a defined manner to impact an obstacle. The sensor data can then comprise measured torques in the one or more joints associated with the impact with the obstacle.

According to an example, the reference data comprises reference torques in the one or more joints of the robotic manipulator to which is applied reference padding of the correct condition and properties or the reference data comprises reference torques in the same one or more joints of an equivalent robotic manipulator to which is applied reference padding of the correct condition and properties.

According to an example, the reference torques are associated with impact of the robotic manipulator with the obstacle or an equivalent obstacle during movement of the robotic manipulator in the defined manner or the reference torques are associated with impact of the equivalent robotic manipulator with the equivalent obstacle during movement of the equivalent robotic manipulator in the defined manner.

According to an example, the at least one sensor comprises one or more position sensors configured to measure positions of one or more parts of the robotic manipulator. The sensor data can then comprise measured positions of the one or more parts of the robotic manipulator associated with the impact with the obstacle. The processing unit is configured to utilize the measured torques in the one or more joints associated with the impact with the obstacle and the measured positions of the one or more parts of the robotic manipulator associated with the impact with the obstacle to calculate one or more forces. The reference data can comprise one or more reference forces.

According to an example, the one or more torque sensors comprises one or more torque sensor in the one or more joints and/or comprises one or more current sensors of one or more motors configured to measure one or more motor currents and an associated processor from which the one or more measured torques are determined from the one or more measured motor currents.

According to an example, the at least one sensor comprises one or more cameras configured to acquire one or more images of the robotic manipulator. The reference data can comprise one or more reference images of the robotic manipulator to which is applied reference padding of the correct condition and properties or can comprise one or more reference images of an equivalent robotic manipulator to the robotic manipulator to which is applied reference padding of the correct condition and properties.

According to an example, the padding applied to the robotic manipulator comprises a plurality of external markers. The reference padding of the correct condition and properties applied to the robotic manipulator in the one or more reference images can then comprise a plurality of external markers or the reference padding of the correct condition and properties applied to the equivalent robotic manipulator in the one or more reference images can comprise a plurality of external markers. The determination of the information relating to the padding applied to the manipulator can then comprise a determination if external markers of the padding in the one or more images of the robotic manipulator is the same as the plurality of external markers of the reference padding in the one or more reference images.

According to an example, the at least one sensor comprises one or more load sensors of the robotic manipulator. The sensor data can then comprise load data associated with movement of the robotic manipulator in a defined manner. The reference data can then comprise reference load data associated with movement in the defined manner of the robotic manipulator to which is applied reference padding of the correct condition and properties or the reference data can comprise reference load data associated with movement in the defined manner of an equivalent robotic manipulator to the robotic manipulator to which is applied reference padding of the correct condition and properties.

According to an example, the information relating to the padding applied to the robotic manipulator comprises information that at least some of the padding is missing.

According to an example, the information relating to the padding applied to the robotic manipulator comprises information that at least some of the padding does not have the correct condition.

According to an example, the information relating to the padding applied to the robotic manipulator comprises information that at least some of the padding does not have the correct properties.

The above described system for testing the padding of a robotic manipulator can be integrated into a robotic system itself, or be a system that is retrofitted to a robotic system. Thus, the processing unit as described above can be a normal processing unit that carries out movement of the robotic manipulator as it normally works, or can be an additional processing unit. Thus, this robotic system comprises a robotic manipulator and a system for testing the padding of a robotic manipulator according to that described above.

From the above, it is clear that FIGS. 1-4 also relate to a method for testing the padding of a robotic manipulator, the method comprising:
acquiring sensor data of a robotic manipulator by at least one sensor;
providing the sensor data to a processing unit;
determining by the processing unit information relating to padding applied to the robotic manipulator, wherein the determining comprises comparing the sensor data with reference data; and
outputting by an output unit the information relating to the padding applied to the robotic manipulator.

In an example, the at least one sensor comprises one or more torque sensors configured to measure torque in one or more joints of the robotic manipulator, and wherein the method comprises using the processing unit to move the robotic manipulator in a defined manner to impact an obstacle, wherein the sensor data comprises measured torques in the one or more joints associated with the impact with the obstacle.

In an example, the reference data comprises reference torques in the one or more joints of the robotic manipulator to which is applied reference padding of the correct condition and properties or comprises reference torques in the same one or more joints of an equivalent robotic manipulator to which is applied reference padding of the correct condition and properties.

In an example, the reference torques are associated with impact of the robotic manipulator with the obstacle or an equivalent obstacle during movement of the robotic manipulator in the defined manner or the reference torques are associated with impact of the equivalent robotic manipulator with the equivalent obstacle during movement of the equivalent robotic manipulator in the defined manner.

In an example, the at least one sensor comprises one or more position sensors and wherein the method comprises measuring positions of one or more parts of the robotic manipulator, wherein the sensor data comprises measured positions of the one or more parts of the robotic manipulator associated with the impact with the obstacle, wherein the method comprises utilizing by the processing unit the measured torques in the one or more joints associated with the impact with the obstacle and the measured positions of the one or more parts of the robotic manipulator associated with the impact with the obstacle to calculate one or more forces, and wherein the reference data comprises one or more reference forces.

In an example, the one or more torque sensors comprises one or more torque sensors in the one or more joints and/or comprises one or more current sensors of one or more motors configured to measure one or more motor currents and an associated processor from which the one or more measured torques are determined from the one or more measured motor currents.

In an example, the at least one sensor comprises one or more cameras and wherein the method comprises acquiring one or more images of the robotic manipulator, and wherein the reference data comprises one or more reference images of the robotic manipulator to which is applied reference padding of the correct condition and properties or comprises one or more reference images of an equivalent robotic manipulator to the robotic manipulator to which is applied reference padding of the correct condition and properties.

In an example, the padding applied to the robotic manipulator comprises a plurality of external markers, and wherein the reference padding of the correct condition and properties applied to the robotic manipulator in the one or more reference images comprises a plurality of external markers or the reference padding of the correct condition and properties applied to the equivalent robotic manipulator in the one or more reference images comprises a plurality of external markers, and wherein the determining the information relating to the padding applied to the manipulator comprises determining if external markers of the padding in the one or more images of the robotic manipulator is the same as the plurality of external markers of the reference padding in the one or more reference images.

In an example, the at least one sensor comprises one or more load sensors of the robotic manipulator, and wherein the sensor data comprises load data associated with movement of the robotic manipulator in a defined manner, and wherein the reference data comprises reference load data associated with movement in the defined manner of the robotic manipulator to which is applied reference padding of the correct condition and properties or the reference data comprises reference load data associated with movement in the defined manner of an equivalent robotic manipulator to the robotic manipulator to which is applied reference padding of the correct condition and properties.

In an example, the information relating to the padding applied to the robotic manipulator comprises information that at least some of the padding is missing.

In an example, the information relating to the padding applied to the robotic manipulator comprises information that at least some of the padding does not have the correct condition.

In an example, the information relating to the padding applied to the robotic manipulator comprises information that at least some of the padding does not have the correct properties.

Continuing with FIGS. 1 and 2, these represent diagrammatically in FIG. 1 a situation where a robotic manipulator impacts a human body region when padding is not present or when padding is present that does not have the correct properties leading to injury of the person, and the situation where a correctly padded robot manipulator impacts the human body but due to the correct positioning and properties of the padding the person is not injured. FIG. 2 then shows graphically the contact area, the contact force, and the contact pressure as a function of time for the impact of the robotic manipulator with and without padding moving in the defined manner against a known object. This information forms the basis behind the currently described system and method for testing the padding of a robotic manipulator, where this information acquired periodically can be compared against reference data.

The following relate to a number of detailed descriptions of embodiments of how this is undertaken.

Method 1:

Moving the relevant part(s) of a robotic manipulator which is/are padded with a defined motion against a fixed obstacle at the manipulator itself (e.g. manipulator base, a different part/joint within reach, additional arm) or near the manipulator (e.g. pedestal) and measure the torque (directly with a sensor or indirectly via motor currents) in the robot joints on impact with the fixed obstacle and compare the torque values with a reference torque values (stored locally or remotely).

Alternatively, a contact force can be computed from the measured joint torques and the joint positions of the manipulator, such that the contact force can be compared to a reference value.

The values of joint torques or contact forces used in the comparison of actual vs. stored reference can be peak values detected during the defined contact motion.

Alternatively, they can be time series of joint torques or contact forces that are compared to reference time series. Furthermore, it is possible to compute integrated quantities such as linear momentum transfer or energy transfer from the time series and to compare these to stored reference values.

Specifically, the data to measure during the defined diagnostic contact motion can include:
Joint torques as a function of time, and/or
Robot position as a function of time.

Measurements over time can include times before actual contact is made, during the contact situation while padding or similar viscoelastic damping material is compressed and released, as well as after the contact situation when the defined robot motion has retracted from the contact configuration.

Calculated quantities to use in the analysis of the time series can include:
Cartesian position of the point of contact on the (padded) robot surface as a function of time
Cartesian contact forces at the point of contact on the (padded) robot surface computed from joint torques, joint positions and manipulator kinematic structure; such forces can be computed as function of time
Linear momentum transfer during the defined motion calculated as the integral of the contact force over the contact time
Energy transfer during the defined motion calculated as the integral of the contact force over the contact displacement
Further derived quantities, such as contact pressures, energy flux densities, power flux densities

This method uses a dedicated robot movement and requires time to execute and to analyze the data. The method would be applied for example at relevant times or at regular intervals to verify the proper condition of the padding elements. Relevant times can be commissioning or restart of a production application.

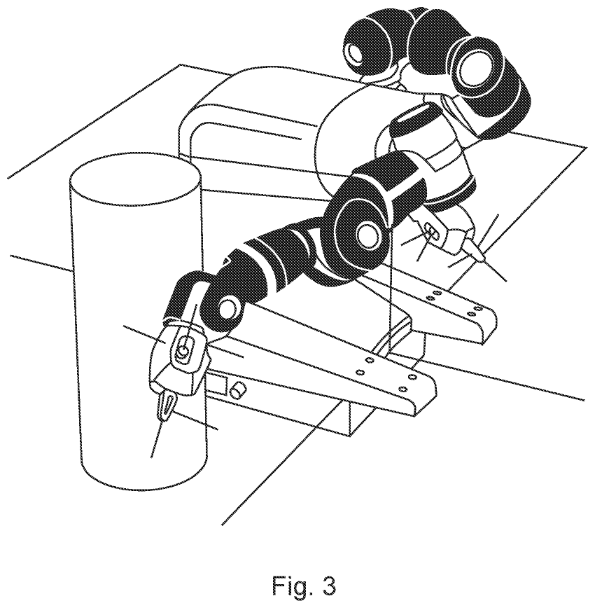

FIG. 3 shows a detailed representation, where the padding applied to the robotic manipulator is shown in the black shaded portions of the image and where x, y and z Cartesian axes are represented in appropriate positions by the mutually orthogonal lines.

Method 2:

A camera at/near the manipulator could be used to inspect the padding and compare the images with a reference picture which was taken e.g. after production (with proper padding material) and stored locally or on any kind of accessible storage device. This method is able to detect visually damaged or missing padding.

Markers on the padding itself (e.g. dot pattern or similar) can help considerably with the camera inspection. With a dot pattern equally spread on the padding, a camera can check for existence as well as correct shape of all expected dots. If there is one dot missing or not in a proper shape, padding is probably damaged or deformed at that location.

This method can be integrated into an application with minimum cycle time penalty by arranging camera(s) in positions that avoid excessive manipulator motion away from application-related trajectories.

In a particularly advantageous implementation, camera images are arranged to be taken “on-the-fly” without bringing the manipulator to rest at the intended vantage position. This further reduces impact on the application cycle times.

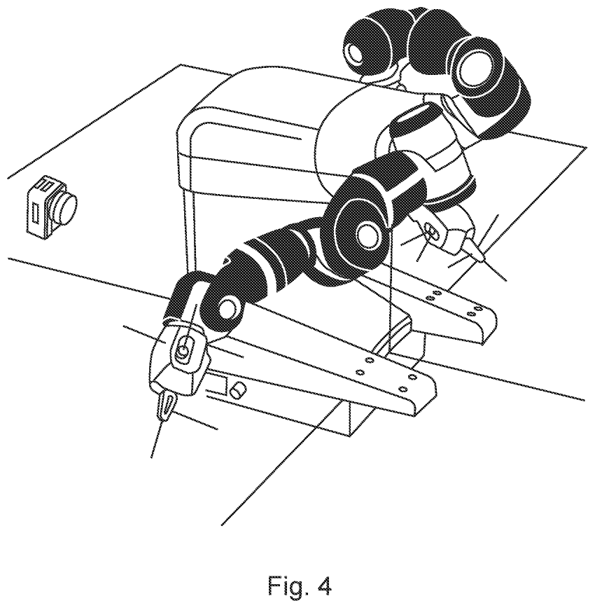

FIG. 4 shows a detailed representation, where the padding applied to the robotic manipulator is shown in the black shaded portions of the image and where x, y and z Cartesian axes are represented in appropriate positions by the mutually orthogonal lines.

Method 3:

Using a defined motion (“Load identification”) which is already implemented for estimating the weight (and other properties) of a payload in order to estimate the weight of the attached padding (and comparing with a reference value). This method is suitable to detect a missing padding whose weight is larger than the resolution of the load identification method.

This method uses a dedicated robot movement, often referred to as “load identification”, which requires time to execute and to analyze. The method would be applied for example at relevant times or at regular intervals to verify the proper condition of the padding elements. Relevant times can be commissioning or restart of a production application.

Advantages of this method are that it does not use physical contact and does not require additional external sensing apparatus.

For all Methods

Based on a time interval, the robot controller can issue a message to the operator or a signal to a cell-/line PLC and the operator or the PLC orders one or several methods above to be executed.

Every time the robot is in a certain position (e.g. home position) at the end of a production cycle, one or several methods above can be executed automatically, before the next production cycle starts.

If a defined motion or movement (as described above) is included in the regular production cycle, the estimated weight of the padding can be constantly compared with a reference value during the production cycle. In case of a deviation (which can be specified in the robot controller), the robot can be stopped and/or a message/signal can be issued to inform the operator/cell-/line PLC.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In an example, the at least one sensor comprises one or more torque sensors configured to measure torque in one or more joints of the robotic manipulator. The processing unit is configured to move the robotic manipulator in a defined manner to impact an obstacle. The sensor data can then comprise measured torques in the one or more joints associated with the impact with the obstacle.

In this manner, torques are measured during the impact of a robotic manipulator, to which padding should be applied, with a known object when the manipulator moves in a specific way. The magnitude and temporal profile of the torques are then compared against reference torque data for the same robotic manipulator or a different robotic manipulator of the same design to which is applied the correct padding, and where reference torque data are measured for this robotic manipulator impacting the same known object when the robotic manipulator moves in the same specific way. In this way, it can be determined if parts of the padding are missing and even if the padding is there, it can be determined if the padding has the correct properties and is providing the required damping during the impact.

Thus, when a robotic manipulator is first commissioned, where the correct padding is applied to the robotic manipulator, it can go through a defined movement and impact a known object in a known manner and the torques are measured, and this information can be stored as reference data. Subsequently, the robotic manipulator enters a test protocol where it goes through the same defined movement and impacts the known object in the known manner, and the torques are measured and compared against the reference data to determine the integrity of the padding.

However, the reference data need not be acquired for the exact same robotic manipulator, but can be determined at for example a site of the robotic manipulator manufacturer. Here, a robotic manipulator of the same model goes through the defined movement and impacts a known object and torque data are measured and stored as reference data. This is then stored in a manner accessible by a processing unit of a robotic manipulator at a customer site. Then, the robotic manipulator at the customer site periodically goes through the same defined movement and impacts the same known object, or the same type of known object, and again measures torques which can be compared against the reference data to determine if the padding is there and if the padding is there, whether it still has the same, required properties as the padding used in providing the reference data.

In an example, the reference data comprises reference torques in the one or more joints of the robotic manipulator to which is applied reference padding of the correct condition and properties or the reference data comprises reference torques in the same one or more joints of an equivalent robotic manipulator to which is applied reference padding of the correct condition and properties.

In an example, the reference torques are associated with impact of the robotic manipulator with the obstacle or an equivalent obstacle during movement of the robotic manipulator in the defined manner or the reference torques are associated with impact of the equivalent robotic manipulator with the equivalent obstacle during movement of the equivalent robotic manipulator in the defined manner.

In an example, the at least one sensor comprises one or more position sensors configured to measure positions of one or more parts of the robotic manipulator. The sensor data can then comprise measured positions of the one or more parts of the robotic manipulator associated with the impact with the obstacle. The processing unit is configured to utilize the measured torques in the one or more joints associated with the impact with the obstacle and the measured positions of the one or more parts of the robotic manipulator associated with the impact with the obstacle to calculate one or more forces. The reference data can comprise one or more reference forces.

Thus, by providing both measured torques and position data, which can be expressed as a function of time, further detailed information is provided regarding the impact from which a more precise determination of whether padding is still in place and for padding that is in place whether it is providing the correct damping properties.

In an example, the one or more torque sensors comprises one or more torque sensors in the one or more joints and/or comprises one or more current sensors of one or more motors configured to measure one or more motor currents and an associated processor from which the one or more measured torques are determined from the one or more measured motor currents.

Thus, specific torque sensors can be utilized or torques can be determined from currents of motors powering the joints of the robotic manipulator.

In an example, the at least one sensor comprises one or more cameras configured to acquire one or more images of the robotic manipulator. The reference data can comprise one or more reference images of the robotic manipulator to which is applied reference padding of the correct condition and properties or can comprise one or more reference images of an equivalent robotic manipulator to the robotic manipulator to which is applied reference padding of the correct condition and properties.

In an example, the padding applied to the robotic manipulator comprises a plurality of external markers. The reference padding of the correct condition and properties applied to the robotic manipulator in the one or more reference images can then comprise a plurality of external markers or the reference padding of the correct condition and properties applied to the equivalent robotic manipulator in the one or more reference images can comprise a plurality of external markers. The determination of the information relating to the padding applied to the manipulator can then comprise a determination if external markers of the padding in the one or more images of the robotic manipulator is the same as the plurality of external markers of the reference padding in the one or more reference images.

In other words, image analysis can be utilized to determine if all the padding is there, where this can be facilitated through markers being on the padding.

The integrity of the padding can be determined without the need for the robotic manipulator to impact on obstacle, where automatic visual inspection of the padding is carried out from image analysis of periodically acquired images.

The integrity of the padding can however be determined from image analysis of the time of impact, relating to how the padding has deformed during the impact. Thus, for example padding that has lost its required properties can deform more rapidly than it should, and deform to a greater extent than it should during the impact.

The integrity of the padding can also be determined because following an impact, padding that does not have the correct properties can take longer to spring back to its correct shape and this can be used to determine that the padding has lost its required properties.

In an example, the at least one sensor comprises one or more load sensors of the robotic manipulator. The sensor data can then comprise load data associated with movement of the robotic manipulator in a defined manner. The reference data can then comprise reference load data associated with movement in the defined manner of the robotic manipulator to which is applied reference padding of the correct condition and properties or the reference data can comprise reference load data associated with movement in the defined manner of an equivalent robotic manipulator to the robotic manipulator to which is applied reference padding of the correct condition and properties.

In an example, the information relating to the padding applied to the robotic manipulator comprises information that at least some of the padding is missing.

In an example, the information relating to the padding applied to the robotic manipulator comprises information that at least some of the padding does not have the correct condition.

In an example, the information relating to the padding applied to the robotic manipulator comprises information that at least some of the padding does not have the correct properties.

In a second aspect, there is provided a robotic system comprising:
a robotic manipulator; and
a system for testing the padding of a robotic manipulator according to the first aspect.

In a third aspect, there is provided a method for testing the padding of a robotic manipulator, the method comprising:
acquiring sensor data of a robotic manipulator by at least one sensor;
providing the sensor data to a processing unit;
determining by the processing unit information relating to padding applied to the robotic manipulator, wherein the determining comprises comparing the sensor data with reference data; and
outputting by an output unit the information relating to the padding applied to the robotic manipulator.

The above aspects and examples will become apparent from and be elucidated with reference to the embodiments described hereinafter.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for testing a padding of a robotic manipulator, the system comprising:
at least one sensor;
a processing unit; and
an output unit;
wherein the at least one sensor is configured to acquire sensor data of the robotic manipulator;
wherein the at least one sensor is configured to provide the sensor data to the processing unit;
wherein the processing unit is configured to determine information relating to the padding applied to the robotic manipulator, the determined information comprising a comparison of the sensor data with reference data; and
wherein the output unit is configured to output the information relating to the padding applied to the robotic manipulator.

2. The system according to claim 1, wherein the at least one sensor comprises one or more torque sensors configured to measure torque in one or more joints of the robotic manipulator, wherein the processing unit is configured to move the robotic manipulator in a defined manner to impact an obstacle, and wherein the sensor data comprises measured torques in the one or more joints associated with the impact with the obstacle.

3. The system according to claim 2, wherein the reference data comprises reference torques in the one or more joints of the robotic manipulator to which is applied reference padding of the correct condition and properties or comprises reference torques in the same one or more joints of an equivalent robotic manipulator to which is applied reference padding of the correct condition and properties.

4. The system according to claim 3, wherein the reference torques are associated with impact of the robotic manipulator with the obstacle or an equivalent obstacle during movement of the robotic manipulator in the defined manner or the reference torques are associated with impact of the equivalent robotic manipulator with the equivalent obstacle during movement of the equivalent robotic manipulator in the defined manner.

5. The system according to claim 2, wherein the at least one sensor comprises one or more position sensors configured to measure positions of one or more parts of the robotic manipulator, wherein the sensor data comprises measured positions of the one or more parts of the robotic manipulator associated with the impact with the obstacle, wherein the processing unit is configured to utilize the measured torques in the one or more joints associated with the impact with the obstacle and the measured positions of the one or more parts of the robotic manipulator associated with the impact with the obstacle to calculate one or more forces, and wherein the reference data comprises one or more reference forces.

6. The system according to claim 2, wherein the one or more torque sensors comprises one or more torque sensors in the one or more joints and/or comprises one or more current sensors of one or more motors configured to measure one or more motor currents and an associated processor from which the one or more measured torques are determined from the one or more measured motor currents.

7. The system according to claim 1, wherein the at least one sensor comprises one or more cameras configured to acquire one or more images of the robotic manipulator, and wherein the reference data comprises one or more reference images of the robotic manipulator to which is applied reference padding of the correct condition and properties or comprises one or more reference images of an equivalent robotic manipulator to the robotic manipulator to which is applied reference padding of the correct condition and properties.

8. The system according to claim 7, wherein the padding applied to the robotic manipulator comprises a plurality of external markers, and wherein the reference padding of the correct condition and properties applied to the robotic manipulator in one or more reference images comprises a plurality of external markers or the reference padding of the correct condition and properties applied to the equivalent robotic manipulator in the one or more reference images comprises a plurality of external markers, and wherein the determination of the information relating to the padding applied to the manipulator comprises a determination if external markers of the padding in the one or more images of the robotic manipulator is the same as the plurality of external markers of the reference padding in the one or more reference images.

9. The system according to claim 1, wherein the at least one sensor comprises one or more load sensors of the robotic manipulator, and wherein the sensor data comprises load data associated with movement of the robotic manipulator in a defined manner, and wherein the reference data comprises reference load data associated with movement in the defined manner of the robotic manipulator to which is applied reference padding of the correct condition and properties or the reference data comprises reference load data associated with movement in the defined manner of an equivalent robotic manipulator to the robotic manipulator to which is applied reference padding of the correct condition and properties.

10. The system according to claim 1, wherein the information relating to the padding applied to the robotic manipulator comprises information that at least some of the padding is missing.

11. The system according to claim 1, wherein the information relating to the padding applied to the robotic manipulator comprises information that at least some of the padding does not have the correct condition.

12. The system according to claim 1, wherein the information relating to the padding applied to the robotic manipulator comprises information that at least some of the padding does not have the correct properties.

13. The system according of claim 1, further comprising the robotic manipulator.

14. A method for testing a padding of a robotic manipulator, the method comprising:
acquiring sensor data of the robotic manipulator by at least one sensor;
providing the sensor data to a processing unit;
determining by the processing unit information relating to the padding applied to the robotic manipulator, wherein the determining comprises comparing the sensor data with reference data; and
outputting by an output unit the information relating to the padding applied to the robotic manipulator.

15. The method according to claim 14, wherein the at least one sensor comprises one or more torque sensors configured to measure torque in one or more joints of the robotic manipulator, wherein the processing unit is configured to move the robotic manipulator in a defined manner to impact an obstacle, and wherein the sensor data comprises measured torques in the one or more joints associated with the impact with the obstacle.

16. The method according to claim 15, wherein the reference data comprises reference torques in the one or more joints of the robotic manipulator to which is applied reference padding of the correct condition and properties or comprises reference torques in the same one or more joints of an equivalent robotic manipulator to which is applied reference padding of the correct condition and properties.

17. The method according to claim 16, wherein the reference torques are associated with impact of the robotic manipulator with the obstacle or an equivalent obstacle during movement of the robotic manipulator in the defined manner or the reference torques are associated with impact of the equivalent robotic manipulator with the equivalent obstacle during movement of the equivalent robotic manipulator in the defined manner.

18. The method according to claim 15, wherein the at least one sensor comprises one or more position sensors configured to measure positions of one or more parts of the robotic manipulator, wherein the sensor data comprises measured positions of the one or more parts of the robotic manipulator associated with the impact with the obstacle, wherein the processing unit is configured to utilize the measured torques in the one or more joints associated with the impact with the obstacle and the measured positions of the one or more parts of the robotic manipulator associated with the impact with the obstacle to calculate one or more forces, and wherein the reference data comprises one or more reference forces.

19. The method according to claim 15, wherein the one or more torque sensors comprises one or more torque sensors in the one or more joints and/or comprises one or more current sensors of one or more motors configured to measure one or more motor currents and an associated processor from which the one or more measured torques are determined from the one or more measured motor currents.

20. The method according to claim 1, wherein the at least one sensor comprises one or more cameras configured to acquire one or more images of the robotic manipulator, and wherein the reference data comprises one or more reference images of the robotic manipulator to which is applied reference padding of the correct condition and properties or comprises one or more reference images of an equivalent robotic manipulator to the robotic manipulator to which is applied reference padding of the correct condition and properties.
